(19) United States
(12) Patent Application Publication
(10) Pub. No.: US 2024/0097159 A1
(43) Pub. Date: Mar. 21, 2024

(54) HYDROGEN PUMP FOR A FLOW BATTERY

(71) Applicant: ESS TECH, INC., Wilsonville, OR (US)

(72) Inventors: Kyle Maurice, Portland, OR (US); Nathan Imholt, Beaverton, OR (US)

(21) Appl. No.: 18/471,213

(22) Filed: Sep. 20, 2023

Related U.S. Application Data
(60) Provisional application No. 63/376,555, filed on Sep. 21, 2022.

(51) Int. Cl. H01M 8/04089; F01D 15/08; H01M 8/04746; H01M 8/18

(52) U.S. Cl. CPC H01M 8/04089; F01D 15/08; H01M 8/04753; H01M 8/04776; H01M 8/188

(57) ABSTRACT

Systems and methods are provided for pumping hydrogen within an electrochemical cell system. In one example, a liquid driven hydrogen pump includes an impeller positioned within a flow path of a gas, and a turbine coupled to the impeller by a shaft and positioned within a flow path of a liquid. A flow of the liquid is driven by a liquid pump based on operation of the electrochemical cell system and the flow of the liquid across the turbine drives rotation of the impeller and an increase in a flow of the gas.

### CROSS REFERENCE TO RELATED APPLICATIONS

The present application claims priority to U.S. Provisional Application No. 63/376,555 entitled “HYDROGEN PUMP FOR A FLOW BATTERY”, filed on Sep. 21, 2022. The entire contents of the above identified application is hereby incorporated by reference for all purposes.

### FIELD

The present description relates generally to gas management in an electrochemical cell such as redox flow battery.

### BACKGROUND AND SUMMARY

Redox flow batteries are suitable for grid-scale storage applications due to their capability for scaling power and capacity independently, as well as for charging and discharging over thousands of cycles with reduced performance losses in comparison to conventional battery technologies. An all-iron hybrid redox flow battery is particularly attractive due to incorporation of low-cost, earth-abundant materials. In general, iron redox flow batteries (IFBs) rely on iron, salt, and water for electrolyte, thus including simple, earth-abundant, and inexpensive materials, and eliminating incorporation of harsh chemicals and reducing an environmental footprint thereof.

The IFB may include a positive (redox) electrode where a redox reaction occurs and a negative (plating) electrode where ferrous iron (Fe²⁺) in the electrolyte may be reduced and plated. Various side reactions may compete with the Fe²⁺ reduction, including proton reduction, iron corrosion, and iron plating oxidation:

| | | |
|---|---|---|
| H⁺ + e⁻ ↔ ½H₂ | (proton reduction) | (1) |
| Fe⁰ + 2H⁺ ↔ Fe²⁺ + H₂ | (iron corrosion) | (2) |
| 2Fe³⁺ + Fe⁰ ↔ 3Fe²⁺ | (iron plating oxidation) | (3) |

As most side reactions occur at the plating electrode, IFB cycling capabilities may be limited by available iron plating on the plating electrode. Exemplary attempts to ameliorate iron plating loss have focused on catalytic electrolyte rebalancing to address hydrogen (H₂) gas generation from equations (1) and (2) and electrolyte charge imbalances (e.g., excess Fe³⁺) from equation (3) and ion crossover.

Fe³⁺+½H₂→Fe²⁺+H⁺ (electrolyte rebalancing) (4)

To rebalance electrolyte via the electrolyte rebalancing reaction (equation 4), the redox flow battery system may include a rebalancing reactor wherein hydrogen gas is reacted with electrolyte, often in the presence of a catalyst. The source of hydrogen gas for the electrolyte rebalancing reaction may be hydrogen evolved from side reactions and/or hydrogen supplied from a separate hydrogen tank. For this reason, the redox flow battery system may demand transfer of hydrogen from storage areas (either above the electrolyte tank or a supplementary tank) to the rebalancing reactor and transfer of any unreacted hydrogen from the rebalancing reactor back to the storage areas. However, commercially available hydrogen pumps may be too large to be readily incorporated into the redox flow battery system for facilitating hydrogen delivery. Furthermore, due to the highly volatile and explosive nature of hydrogen gas, materials able to accommodate a reactivity of hydrogen and withstand the corrosive environment of the redox flow battery system are demanded for components used for hydrogen management.

In some examples, flow of hydrogen gas within a redox flow battery system may be addressed using venturi injectors to inject the hydrogen gas into a liquid stream, pumping the liquid using a dedicated liquid pump, and then removing the hydrogen gas from the liquid at the desired location using a liquid/gas separator. However, this system of moving hydrogen gas introduces multiple points of potential mechanical degradation and leakage between the dedicated liquid pump, venturi injectors, and liquid/gas separator. Further, the dedicated liquid pump increases a parasitic power load on the redox flow battery system. The added equipment also increases a footprint and heat load of the redox flow battery system.

In one example, the issues may be at least partially addressed by a liquid driven hydrogen pump for an electrochemical cell system, comprising: a pumping device positioned within a flow path of a gas, and a turbine coupled to an impeller by a shaft and positioned within a flow path of a liquid, a flow of the liquid driven by a liquid pump based on operation of the electrochemical cell system, and wherein the flow of the liquid across the turbine drives rotation of the pumping device and an increase in a flow of the gas. In this way, a single pump of the redox flow battery may be used to move both electrolytes and hydrogen gas, and a demand for parasitic power may be reduced.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example redox flow battery system including indication of a flow of hydrogen to rebalancing reactors.

FIG. 2 shows an example of an electrolyte driven hydrogen pump.

FIG. 3 shows the electrolyte driven hydrogen pump of FIG. 2 installed in a redox flow battery system.

FIG. 4 shows a schematic example of electrolyte and hydrogen flow using an electrolyte driven hydrogen pump.

FIG. 5 shows a flow chart of an example of a method for operating an electrolyte driven hydrogen pump.

### DETAILED DESCRIPTION

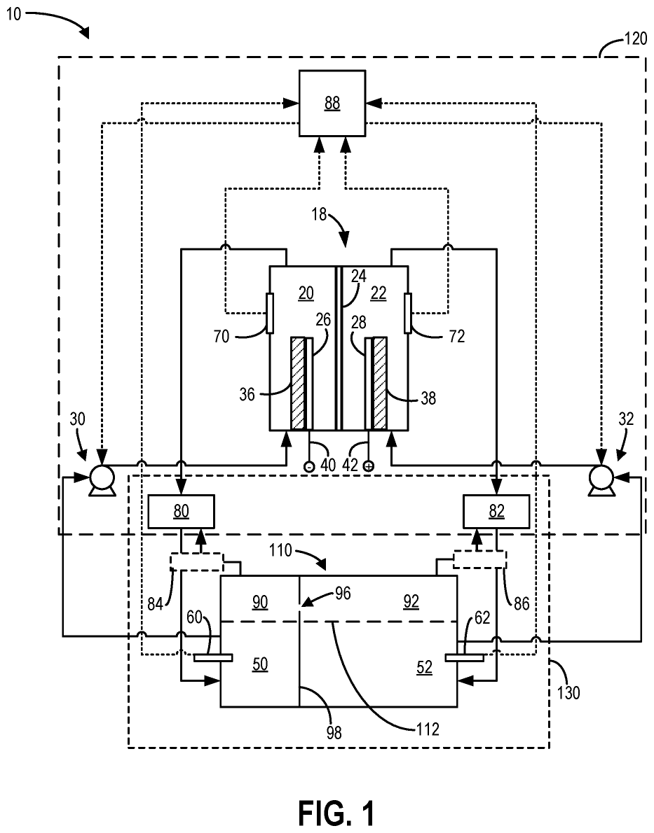

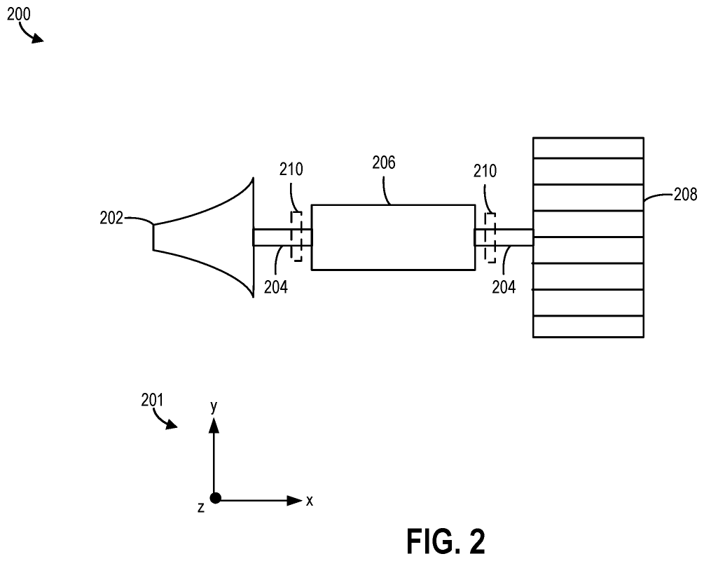

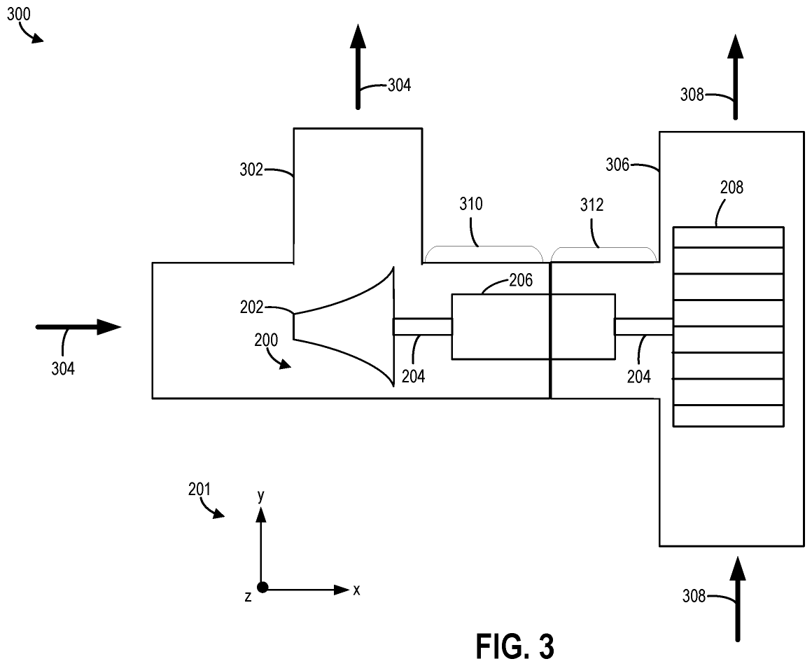

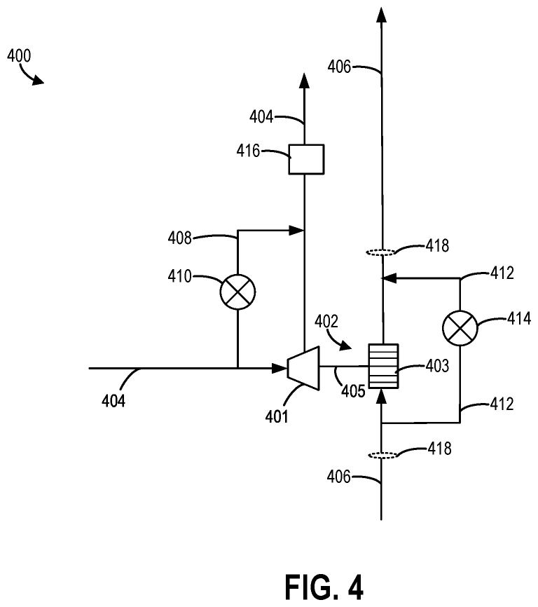

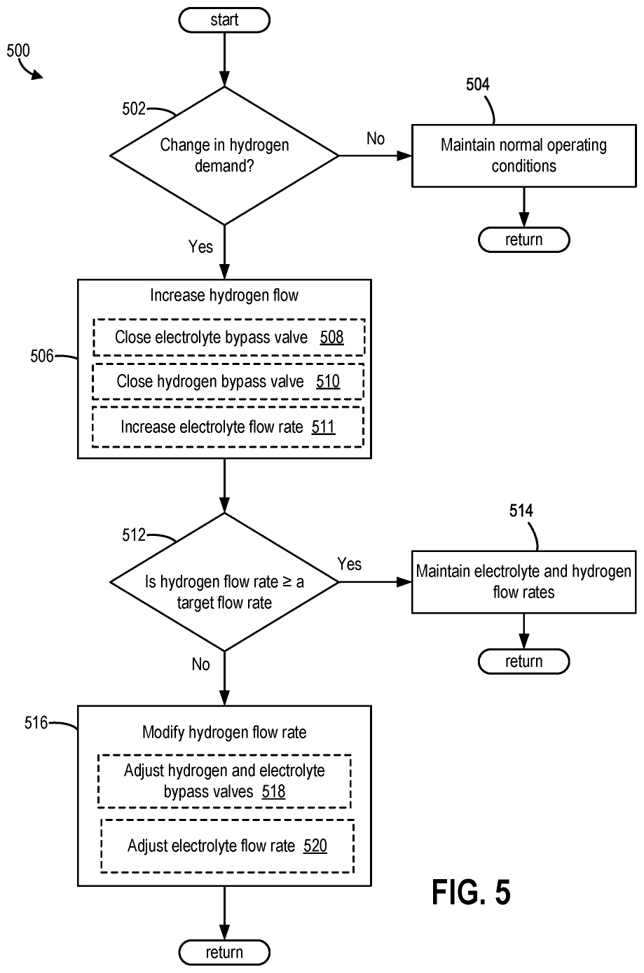

The following description relates to systems and methods for pumping hydrogen in an electrochemical cell system. As one example, the electrochemical cell system may be a redox flow battery system. An example of a redox flow battery system which may demand a hydrogen pump is shown schematically in FIG. 1. As described in FIG. 1, the redox flow battery system may include pumps for circulating electrolyte between an electrolyte tank and battery electrode compartments. The circulating electrolyte may power a liquid driven hydrogen pump, such as the liquid driven hydrogen pump illustrated in FIG. 2. In some examples, such as where the liquid driven hydrogen pump is utilized in the redox flow battery system of FIG. 1, the liquid of the liquid driven hydrogen pump may be an electrolyte, and the pump may be herein referred to as an electrolyte driven hydrogen pump. However, other liquids besides electrolytes have been considered. Further, other gasses or mixtures of gasses in addition to hydrogen gas may be driven by the liquid driven hydrogen pump. The electrolyte driven hydrogen pump of FIG. 2 is depicted in FIG. 3 installed in both a hydrogen passage and electrolyte passage of a redox flow battery system. FIG. 4 schematically shows how hydrogen and electrolyte may flow within a redox flow battery system using an electrolyte driven hydrogen pump and bypass valves. The electrolyte driven hydrogen pump may be controlled via a method shown in FIG. 5.

As shown in FIG. 1, in a redox flow battery system 10, a negative electrode 26 may be referred to as a plating electrode and a positive electrode 28 may be referred to as a redox electrode. A negative electrolyte within a plating side (e.g., a negative electrode compartment 20) of a redox flow battery cell 18 may be referred to as a plating electrolyte, and a positive electrolyte on a redox side (e.g., a positive electrode compartment 22) of the redox flow battery cell 18 may be referred to as a redox electrolyte.

“Anode” refers to an electrode where electroactive material loses electrons and “cathode” refers to an electrode where electroactive material gains electrons. During battery charge, the negative electrolyte gains electrons at the negative electrode 26, and the negative electrode 26 is the cathode of the electrochemical reaction. During battery discharge, the negative electrolyte loses electrons, and the negative electrode 26 is the anode of the electrochemical reaction. Alternatively, during battery discharge, the negative electrolyte and the negative electrode 26 may be respectively referred to as an anolyte and the anode of the electrochemical reaction, while the positive electrolyte and the positive electrode 28 may be respectively referred to as a catholyte and the cathode of the electrochemical reaction. During battery charge, the negative electrolyte and the negative electrode 26 may be respectively referred to as the catholyte and the cathode of the electrochemical reaction, while the positive electrolyte and the positive electrode 28 may be respectively referred to as the anolyte and the anode of the electrochemical reaction. For simplicity, the terms “positive” and “negative” are used herein to refer to the electrodes, electrolytes, and electrode compartments in redox flow battery systems.

One example of a hybrid redox flow battery is an all-iron redox flow battery (IFB), in which the electrolyte includes iron ions in the form of iron salts (e.g., FeCl₂, FeCl₃, and the like), wherein the negative electrode 26 includes metal iron. For example, at the negative electrode 26, ferrous iron (Fe²⁺) gains two electrons and plates as iron metal (Fe⁰) onto the negative electrode 26 during battery charge, and Fe⁰ loses two electrons and re-dissolves as Fe²⁺ during battery discharge. At the positive electrode 28, Fe²⁺ loses an electron to form ferric iron (Fe³⁺) during battery charge, and Fe³⁺ gains an electron to form Fe²⁺ during battery discharge. The electrochemical reaction is summarized in equations (1) and (2), wherein the forward reactions (left to right) indicate electrochemical reactions during battery charge, while the reverse reactions (right to left) indicate electrochemical reactions during battery discharge:

| | | | |
|---|---|---|---|
| Fe²⁺ + 2e⁻ ↔ Fe⁰ | −0.44 V | (negative electrode) | (1) |
| Fe²⁺↔ 2Fe³⁺ + 2e⁻ | +0.77 V | (positive electrode) | (2) |

As discussed above, the negative electrolyte used in the IFB may provide a sufficient amount of Fe²⁺ so that, during battery charge, Fe²⁺ may accept two electrons from the negative electrode 26 to form Fe⁰ and plate onto a substrate. During battery discharge, the plated Fe⁰ may lose two electrons, ionizing into Fe²⁺ and dissolving back into the electrolyte. An equilibrium potential of the above reaction is −0.44 V and this reaction therefore provides a negative terminal for the desired system. On the positive side of the IFB, the electrolyte may provide Fe²⁺ during battery charge which loses an electron and oxidizes to Fe³⁺. During battery discharge, Fe³⁺ provided by the electrolyte becomes Fe²⁺ by absorbing an electron provided by the positive electrode 28. An equilibrium potential of this reaction is +0.77 V, creating a positive terminal for the desired system.

The IFB may provide the ability to charge and recharge electrolytes therein in contrast to other battery types utilizing non-regenerating electrolytes. Charge may be achieved by respectively applying an electric current across the electrodes 26 and 28 via terminals 40 and 42. The negative electrode 26 may be electrically coupled via the terminal 40 to a negative side of a voltage source so that electrons may be delivered to the negative electrolyte via the positive electrode 28 (e.g., as Fe²⁺ is oxidized to Fe³⁺ in the positive electrolyte in the positive electrode compartment 22). The electrons provided to the negative electrode 26 may reduce the Fe²⁺ in the negative electrolyte to form Fe⁰ at the (plating) substrate, causing the Fe²⁺ to plate onto the negative electrode 26.

Discharge may be sustained while Fe⁰ remains available to the negative electrolyte for oxidation and while Fe³⁺ remains available in the positive electrolyte for reduction. As an example, Fe³⁺ availability may be maintained by increasing a concentration or a volume of the positive electrolyte in the positive electrode compartment 22 side of the redox flow battery cell 18 to provide additional Fe³⁺ ions via an external source, such as an external positive electrolyte chamber 52. More commonly, availability of Fe⁰ during discharge may be an issue in IFB systems, wherein the Fe⁰ available for discharge may be proportional to a surface area and a volume of the negative electrode substrate, as well as to a plating efficiency. Charge capacity may be dependent on the availability of Fe²⁺ in the negative electrode compartment 20. As an example, Fe²⁺ availability may be maintained by providing additional Fe²⁺ ions via an external source, such as an external negative electrolyte chamber 50 to increase a concentration or a volume of the negative electrolyte to the negative electrode compartment 20 side of the redox flow battery cell 18.

In an IFB, the positive electrolyte may include ferrous iron, ferric iron, ferric complexes, or any combination thereof, while the negative electrolyte may include ferrous iron or ferrous complexes, depending on a state of charge (SOC) of the IFB system. As previously mentioned, utilization of iron ions in both the negative electrolyte and the positive electrolyte may allow for utilization of the same electrolytic species on both sides of the redox flow battery cell 18, which may reduce electrolyte cross-contamination and may increase the efficiency of the IFB system, resulting in less electrolyte replacement as compared to other redox flow battery systems.

Efficiency losses in an IFB may result from electrolyte crossover through a separator 24 (e.g., ion-exchange membrane barrier, microporous membrane, and the like). For example, Fe³⁺ ions in the positive electrolyte may be driven toward the negative electrolyte by a Fe³⁺ ion concentration gradient and an electrophoretic force across the separator 24. Subsequently, Fe³⁺ ions penetrating the separator 24 and crossing over to the negative electrode compartment 20 may result in coulombic efficiency losses. Fe³⁺ ions crossing over from the low pH redox side (e.g., more acidic positive electrode compartment 22) to the high pH plating side (e.g., less acidic negative electrode compartment 20) may result in precipitation of Fe(OH)₃. Precipitation of Fe(OH)₃ may degrade the separator 24 and cause permanent battery performance and efficiency losses. For example, Fe(OH)₃ precipitate may chemically foul an organic functional group of an ion-exchange membrane or physically clog micropores of the ion-exchange membrane. In either case, due to the Fe(OH)₃ precipitate, membrane ohmic resistance may rise over time and battery performance may degrade. Precipitate may be removed by washing the IFB with acid, but constant maintenance and downtime may be disadvantageous for commercial battery applications. Furthermore, washing may be dependent on regular preparation of electrolyte, contributing to additional processing costs and complexity. Alternatively, adding specific organic acids to the positive electrolyte and the negative electrolyte in response to electrolyte pH changes may mitigate precipitate formation during battery charge and discharge cycling without driving up overall costs. Additionally, implementing a membrane barrier that inhibits Fe³⁺ ion crossover may also mitigate fouling.

Additional coulombic efficiency losses may be caused by reduction of H⁺ (e.g., protons) and subsequent formation of H₂ gas, and a reaction of protons in the negative electrode compartment 20 with electrons supplied at the plated iron metal of the negative electrode 26 to form H₂ gas.

The IFB electrolyte (e.g., FeCl₂, FeCl₃, FeSO₄, Fe₂(SO₄)₃, and the like) may be readily available and may be produced at low costs. In one example, the IFB electrolyte may be formed from ferrous chloride (FeCl₂), potassium chloride (KCl), manganese(II) chloride (MnCl₂), and boric acid (H₃BO₃). The IFB electrolyte may offer higher reclamation value because the same electrolyte may be used for the negative electrolyte and the positive electrolyte, consequently reducing cross-contamination issues as compared to other systems. Furthermore, because of iron's electron configuration, iron may solidify into a generally uniform solid structure during plating thereof on the negative electrode substrate. For zinc and other metals commonly used in hybrid redox batteries, solid dendritic structures may form during plating. A stable electrode morphology of the IFB system may increase the efficiency of the battery in comparison to other redox flow batteries. Further still, iron redox flow batteries may reduce the use of toxic raw materials and may operate at a relatively neutral pH as compared to other redox flow battery electrolytes. Accordingly, IFB systems may reduce environmental hazards as compared with all other current advanced redox flow battery systems in production.

Continuing with FIG. 1, a schematic illustration of the redox flow battery system 10 is shown. The redox flow battery system 10 may include the redox flow battery cell 18 fluidly coupled to an integrated multi-chambered electrolyte storage tank 110. The redox flow battery cell 18 may include the negative electrode compartment 20, separator 24, and positive electrode compartment 22. The separator 24 may include an electrically insulating ionic conducting barrier which prevents bulk mixing of the positive electrolyte and the negative electrolyte while allowing conductance of specific ions therethrough. For example, and as discussed above, the separator 24 may include an ion-exchange membrane and/or a microporous membrane.

The negative electrode compartment 20 may include the negative electrode 26, and the negative electrolyte may include electroactive materials. The positive electrode compartment 22 may include the positive electrode 28, and the positive electrolyte may include electroactive materials. In some examples, multiple redox flow battery cells 18 may be combined in series or in parallel to generate a higher voltage or electric current in the redox flow battery system 10.

Further illustrated in FIG. 1 are negative and positive electrolyte pumps 30 and 32, both used to pump electrolyte solution through the redox flow battery system 10. Electrolytes are stored in one or more tanks external to the cell, and are pumped via the negative and positive electrolyte pumps 30 and 32 through the negative electrode compartment 20 side and the positive electrode compartment 22 side of the redox flow battery cell 18, respectively.

The redox flow battery system 10 may also include a first bipolar plate 36 and a second bipolar plate 38, each positioned along a rear-facing side, e.g., opposite of a side facing the separator 24, of the negative electrode 26 and the positive electrode 28, respectively. The first bipolar plate 36 may be in contact with the negative electrode 26 and the second bipolar plate 38 may be in contact with the positive electrode 28. In other examples, however, the bipolar plates 36 and 38 may be arranged proximate but spaced away from the electrodes 26 and 28 and housed within the respective electrode compartments 20 and 22. In either case, the bipolar plates 36 and 38 may be electrically coupled to the terminals 40 and 42, respectively, either via direct contact therewith or through the negative and positive electrodes 26 and 28, respectively. The IFB electrolytes may be transported to reaction sites at the negative and positive electrodes 26 and 28 by the first and second bipolar plates 36 and 38, resulting from conductive properties of a material of the bipolar plates 36 and 38. Electrolyte flow may also be assisted by the negative and positive electrolyte pumps 30 and 32, facilitating forced convection through the redox flow battery cell 18. Reacted electrochemical species may also be directed away from the reaction sites by a combination of forced convection and a presence of the first and second bipolar plates 36 and 38.

As illustrated in FIG. 1, the redox flow battery cell 18 may further include the negative battery terminal 40 and the positive battery terminal 42. When a charge current is applied to the battery terminals 40 and 42, the positive electrolyte may be oxidized (loses one or more electrons) at the positive electrode 28, and the negative electrolyte may be reduced (gains one or more electrons) at the negative electrode 26. During battery discharge, reverse redox reactions may occur on the electrodes 26 and 28. In other words, the positive electrolyte may be reduced (gains one or more electrons) at the positive electrode 28, and the negative electrolyte may be oxidized (loses one or more electrons) at the negative electrode 26. An electrical potential difference across the battery may be maintained by the electrochemical redox reactions in the positive electrode compartment 22 and the negative electrode compartment 20, and may induce an electric current through a current collector while the reactions are sustained. An amount of energy stored by a redox battery may be limited by an amount of electroactive material available in electrolytes for discharge, depending on a total volume of electrolytes and a solubility of the electroactive materials.

The redox flow battery system 10 may further include the integrated multi-chambered electrolyte storage tank 110. The multi-chambered electrolyte storage tank 110 may be divided by a bulkhead 98. The bulkhead 98 may create multiple chambers within the multi-chambered electrolyte storage tank 110 so that both the positive and negative electrolytes may be included within a single tank. The negative electrolyte chamber 50 holds negative electrolyte including the electroactive materials, and the positive electrolyte chamber 52 holds positive electrolyte including the electroactive materials. The bulkhead 98 may be positioned within the multi-chambered electrolyte storage tank 110 to yield a desired volume ratio between the negative electrolyte chamber 50 and the positive electrolyte chamber 52. In one example, the bulkhead 98 may be positioned to set a volume ratio of the negative and positive electrolyte chambers 50 and 52 according to a stoichiometric ratio between the negative and positive redox reactions. FIG. 1 further illustrates a fill height 112 of the multi-chambered electrolyte storage tank 110, which may indicate a liquid level in each tank compartment. FIG. 1 also shows a gas head space 90 located above the fill height 112 of the negative electrolyte chamber 50, and a gas head space 92 located above the fill height 112 of the positive electrolyte chamber 52. The gas head space 92 may be utilized to store H₂ gas generated through operation of the redox flow battery (e.g., due to proton reduction and iron corrosion side reactions) and conveyed to the multi-chambered electrolyte storage tank 110 with returning electrolyte from the redox flow battery cell 18. The H₂ gas may be separated spontaneously at a gas-liquid interface (e.g., the fill height 112) within the multi-chambered electrolyte storage tank 110, thereby precluding having additional gas-liquid separators as part of the redox flow battery system 10. Once separated from the electrolyte, the H₂ gas may fill the gas head spaces 90 and 92. As such, the stored H₂ gas may aid in purging other gases from the multi-chambered electrolyte storage tank 110, thereby acting as an inert gas blanket for reducing oxidation of electrolyte species, which may help to reduce redox flow battery capacity losses. In this way, utilizing the integrated multi-chambered electrolyte storage tank 110 may forego having separate negative and positive electrolyte storage tanks, hydrogen storage tanks, and gas-liquid separators common to conventional redox flow battery systems, thereby simplifying a system design, reducing a physical footprint of the redox flow battery system 10, and reducing system costs.

FIG. 1 also shows a spillover hole 96, which may create an opening in the bulkhead 98 between the gas head spaces 90 and 92, and may provide a means of equalizing gas pressure between the chambers 50 and 52. The spillover hole 96 may be positioned at a threshold height above the fill height 112. The spillover hole 96 may further enable a capability to self-balance the electrolytes in each of the negative and positive electrolyte chambers 50 and 52 in the event of a battery crossover. In the case of an all-iron redox flow battery system, the same electrolyte (Fe²⁺) is used in both negative and positive electrode compartments 20 and 22, so spilling over of electrolyte between the negative and positive electrolyte chambers 50 and 52 may reduce overall system efficiency, but overall electrolyte composition, battery module performance, and battery module capacity may be maintained. Flange fittings may be utilized for all piping connections for inlets and outlets to and from the multi-chambered electrolyte storage tank 110 to maintain a continuously pressurized state without leaks. The multi-chambered electrolyte storage tank 110 may include at least one outlet from each of the negative and positive electrolyte chambers 50 and 52, and at least one inlet to each of the negative and positive electrolyte chambers 50 and 52. Furthermore, one or more outlet connections may be provided from the gas head spaces 90 and 92 for directing H₂ gas to rebalancing reactors or cells 80 and 82.

Conventionally, hydrogen gas may be directed to rebalancing reactors 80 and 82 or other components which demand hydrogen by a multi-component system relying on liquid pumps, venturi injectors, and liquid/gas separators. As described further below, the multi-component system may be replaced by one or more electrolyte driven hydrogen pumps 84 and 86. In one example electrolyte driven hydrogen pumps 84 and 86 may be positioned so that a hydrogen impeller of electrolyte driven hydrogen pumps 84 and 86 is between one of the gas head spaces 90 and 92 and an inlet of one of rebalancing reactors 80 and 82. Electrolyte driven hydrogen pumps 84 and 86 may take advantage of the movement of electrolyte from rebalancing reactors 80 and 82 to multi-chambered electrolyte storage tank 110 in order to drive a turbine of electrolyte driven hydrogen pumps 84 and 86, the turbine coupled to the hydrogen impeller. In alternate examples, electrolyte driven hydrogen pumps 84 and 86 may be positioned so that the hydrogen impeller of the pumps is positioned after an outlet of (e.g., downstream of) rebalancing reactors 80 and 82. In such a configuration, the electrolyte driven hydrogen pump may take advantage of the movement of electrolyte from electrode compartments 20 and 22 to rebalancing reactors 80 and 82. In this way, hydrogen pressure inside reactor may be modulated between a positive pressure and a negative pressure.

Although not shown in FIG. 1, the integrated multi-chambered electrolyte storage tank 110 may further include one or more heaters thermally coupled to each of the negative electrolyte chamber 50 and the positive electrolyte chamber 52. In alternate examples, only one of the negative and positive electrolyte chambers 50 and 52 may include one or more heaters. In the case where only the positive electrolyte chamber 52 includes one or more heaters, the negative electrolyte may be heated by transferring heat generated at the redox flow battery cell 18 to the negative electrolyte. In this way, the redox flow battery cell 18 may heat and facilitate temperature regulation of the negative electrolyte. The one or more heaters may be actuated by a controller 88 to regulate a temperature of the negative electrolyte chamber 50 and the positive electrolyte chamber 52 independently or together. For example, in response to an electrolyte temperature decreasing below a threshold temperature, the controller 88 may increase a power supplied to one or more heaters so that a heat flux to the electrolyte may be increased. The electrolyte temperature may be indicated by one or more temperature sensors mounted at the multi-chambered electrolyte storage tank 110, such as sensors 60 and 62. As examples, the one or more heaters may include coil type heaters or other immersion heaters immersed in the electrolyte fluid, or surface mantle type heaters that transfer heat conductively through the walls of the negative and positive electrolyte chambers 50 and 52 to heat the fluid therein. Other known types of tank heaters may be employed without departing from the scope of the present disclosure. Furthermore, the controller 88 may deactivate the one or more heaters in the negative and positive electrolyte chambers 50 and 52 in response to a liquid level decreasing below a solids fill threshold level. Said in another way, in some examples, the controller 88 may activate the one or more heaters in the negative and positive electrolyte chambers 50 and 52 only in response to a liquid level increasing above the solids fill threshold level. In this way, activating the one or more heaters without sufficient liquid in the negative and/or positive electrolyte chambers 50, 52 may be averted, thereby reducing a risk of overheating or burning out the heater(s).

Further still, one or more inlet connections may be provided to each of the negative and positive electrolyte chambers 50 and 52 from a field hydration system (not shown). In this way, the field hydration system may facilitate commissioning of the redox flow battery system 10, including installing, filling, and hydrating the redox flow battery system 10, at an end-use location. Furthermore, prior to commissioning the redox flow battery system 10 at the end-use location, the redox flow battery system 10 may be dry-assembled at a battery manufacturing facility different from the end-use location without filling and hydrating the redox flow battery system 10, before delivering the redox flow battery system 10 to the end-use location. In one example, the end-use location may correspond to a location where the redox flow battery system 10 is to be installed and utilized for on-site energy storage. Said another way, the redox flow battery system 10 may be designed such that, once installed and hydrated at the end-use location, a position of the redox flow battery system 10 may become fixed, and the redox flow battery system 10 may no longer be deemed a portable, dry system. Thus, from a perspective of an end-user, the dry, portable redox flow battery system 10 may be delivered on-site, after which the redox flow battery system 10 may be installed, hydrated, and commissioned. Prior to hydration, the redox flow battery system 10 may be referred to as a dry, portable system, the redox flow battery system 10 being free of or without water and wet electrolyte. Once hydrated, the redox flow battery system 10 may be referred to as a wet, non-portable system, the redox flow battery system 10 including wet electrolyte.

Further illustrated in FIG. 1, electrolyte solutions primarily stored in the multi-chambered electrolyte storage tank 110 may be pumped via the negative and positive electrolyte pumps 30 and 32 throughout the redox flow battery system 10. Electrolyte stored in the negative electrolyte chamber 50 may be pumped via the negative electrolyte pump 30 through the negative electrode compartment 20 side of the redox flow battery cell 18, and electrolyte stored in the positive electrolyte chamber 52 may be pumped via the positive electrolyte pump 32 through the positive electrode compartment 22 side of the redox flow battery cell 18.

The electrolyte rebalancing reactors 80 and 82 may be connected in line or in parallel with the recirculating flow paths of the electrolyte at the negative and positive sides of the redox flow battery cell 18, respectively, in the redox flow battery system 10. One or more rebalancing reactors may be connected in-line with the recirculating flow paths of the electrolyte at the negative and positive sides of the battery, and other rebalancing reactors may be connected in parallel, for redundancy (e.g., a rebalancing reactor may be serviced without disrupting battery and rebalancing operations) and for increased rebalancing capacity. In one example, the electrolyte rebalancing reactors 80 and 82 may be placed in a return flow path from the negative and positive electrode compartments 20 and 22 to the negative and positive electrolyte chambers 50 and 52, respectively.

The electrolyte rebalancing reactors 80 and 82 may serve to rebalance electrolyte charge imbalances in the redox flow battery system 10 occurring due to side reactions, ion crossover, and the like, as described herein. In one example, electrolyte rebalancing reactors 80 and 82 may include trickle bed reactors, where the H₂ gas and electrolyte may be contacted at catalyst surfaces in a packed bed for carrying out the electrolyte rebalancing reaction. In other examples, the rebalancing reactors 80 and 82 may include flow-through type reactors that are capable of contacting the H₂ gas and the electrolyte liquid and carrying out the electrolyte rebalancing reactions absent a packed catalyst bed.

During operation of the redox flow battery system 10, sensors and probes may monitor and control chemical properties of the electrolyte such as electrolyte pH, concentration, SOC, and the like. For example, as illustrated in FIG. 1, sensors 62 and 60 maybe be positioned to monitor positive electrolyte and negative electrolyte conditions at the positive electrolyte chamber 52 and the negative electrolyte chamber 50, respectively. In another example, sensors 62 and 60 may each include one or more electrolyte level sensors to indicate a level of electrolyte in the positive electrolyte chamber 52 and the negative electrolyte chamber 50, respectively. As another example, sensors 72 and 70, also illustrated in FIG. 1, may monitor positive electrolyte and negative electrolyte conditions at the positive electrode compartment 22 and the negative electrode compartment 20, respectively. The sensors 72 and 70 may be pH probes, optical probes, pressure sensors, voltage sensors, etc. It will be appreciated that sensors may be positioned at other locations throughout the redox flow battery system 10 to monitor electrolyte chemical properties and other properties.

For example, a sensor may be positioned in an external acid tank (not shown) to monitor acid volume or pH of the external acid tank, wherein acid from the external acid tank may be supplied via an external pump (not shown) to the redox flow battery system 10 in order to reduce precipitate formation in the electrolytes. Additional external tanks and sensors may be installed for supplying other additives to the redox flow battery system 10. For example, various sensors including, temperature, conductivity, and level sensors of a field hydration system may transmit signals to the controller 88. Furthermore, the controller 88 may send signals to actuators such as valves and pumps of the field hydration system during hydration of the redox flow battery system 10. Sensor information may be transmitted to the controller 88 which may in turn actuate the pumps 30 and 32 to control electrolyte flow through the redox flow battery cell 18, or to perform other control functions, as an example. In this manner, the controller 88 may be responsive to one or a combination of sensors and probes.

The redox flow battery system 10 may further include a source of H₂ gas. In one example, the source of H₂ gas may include a separate dedicated hydrogen gas storage tank. The separate dedicated hydrogen gas storage tank may also be fluidically coupled to one or more electrolyte driven hydrogen pumps 84 and 86. In the example of FIG. 1, H₂ gas may be stored in and supplied from the integrated multi-chambered electrolyte storage tank 110. The integrated multi-chambered electrolyte storage tank 110 may supply additional H₂ gas to the positive electrolyte chamber 52 and the negative electrolyte chamber 50. The integrated multi-chambered electrolyte storage tank 110 may alternately supply additional H₂ gas to an inlet of the electrolyte rebalancing reactors 80 and 82. As an example, a mass flow controller or other flow controlling device (which may be controlled by the controller 88) may regulate flow of the H₂ gas from the integrated multi-chambered electrolyte storage tank 110. The integrated multi-chambered electrolyte storage tank 110 may supplement the H₂ gas generated in the redox flow battery system 10. For example, when gas leaks are detected in the redox flow battery system 10 or when a reduction reaction rate is too low at low hydrogen partial pressure, the H₂ gas may be supplied from the integrated multi-chambered electrolyte storage tank 110 in order to rebalance the SOC of the electroactive materials in the positive electrolyte and the negative electrolyte. As an example, the controller 88 may supply the H₂ gas from the integrated multi-chambered electrolyte storage tank 110 in response to a measured change in pH or in response to a measured change in SOC of an electrolyte or an electroactive material.

For example, an increase in pH of the negative electrolyte chamber 50, or the negative electrode compartment 20, may indicate that H₂ gas is leaking from the redox flow battery system 10 and/or that the reaction rate is too slow with the available hydrogen partial pressure, and the controller 88, in response to the pH increase, may increase a supply of H₂ gas from the integrated multi-chambered electrolyte storage tank 110 to the redox flow battery system 10. As a further example, the controller 88 may supply H₂ gas from the integrated multi-chambered electrolyte storage tank 110 in response to a pH change, wherein the pH increases beyond a first threshold pH or decreases beyond a second threshold pH. In the case of an IFB, the controller 88 may supply additional H₂ gas to increase a rate of reduction of Fe³⁺ ions and a rate of production of protons, thereby reducing the pH of the positive electrolyte. Furthermore, the pH of the negative electrolyte may be lowered by hydrogen reduction of Fe³⁺ ions crossing over from the positive electrolyte to the negative electrolyte or by protons, generated at the positive side, crossing over to the negative electrolyte due to a proton concentration gradient and electrophoretic forces. In this manner, the pH of the negative electrolyte may be maintained within a stable region, while reducing the risk of precipitation of Fe³⁺ ions (crossing over from the positive electrode compartment 22) as Fe(OH)₃.

Other control schemes for controlling a supply rate of H₂ gas from the integrated multi-chambered electrolyte storage tank 110 responsive to a change in an electrolyte pH or to a change in an electrolyte SOC, detected by other sensors such as an oxygen-reduction potential (ORP) meter or an optical sensor, may be implemented. Further still, the change in pH or SOC triggering action of the controller 88 may be based on a rate of change or a change measured over a time period. The time period for the rate of change may be predetermined or adjusted based on time constants for the redox flow battery system 10. For example, the time period may be reduced if a recirculation rate is high, and local changes in concentration (e.g., due to side reactions or gas leaks) may quickly be measured since the time constants may be small.

The controller 88 may further execute control schemes based on an operating mode of the redox flow battery system 10. For example, and as discussed in detail below with reference to FIG. 5, the controller may control bypass valves configured in a flow path of hydrogen gas and electrolyte respectively. Opening and closing bypass valves may allow control of a flow rate and pressure of hydrogen gas being pumped by the electrolyte driven hydrogen pump. As another example, the controller 88 may control charging and discharging of the redox flow battery cell 18 so as to cause iron preformation at the negative electrode 26 during system conditioning (where system conditioning may include an operating mode employed to optimize electrochemical performance of the redox flow battery system 10 outside of battery cycling). That is, during system conditioning, the controller 88 may adjust one or more operating conditions of the redox flow battery system 10 to plate iron metal on the negative electrode 26 to improve a battery charge capacity during subsequent battery cycling (thus, the iron metal may be preformed for battery cycling). The controller 88 may further execute electrolyte rebalancing as discussed above to rid the redox flow battery system 10 of excess hydrogen gas and reduce Fe³⁺ ion concentration. In this way, preforming iron at the negative electrode 26 and running electrolyte rebalancing during the system conditioning may increase an overall capacity of the redox flow battery cell 18 during battery cycling by mitigating iron plating loss. As used herein, battery cycling (also referred to as “charge cycling”) may include alternating between a charging mode and a discharging mode of the redox flow battery system 10.

It will be appreciated that all components apart from the sensors 60 and 62 and the integrated multi-chambered electrolyte storage tank 110 (and components included therein) may be considered as being included in a power module 120. As such, the redox flow battery system 10 may be described as including the power module 120 fluidly coupled to the integrated multi-chambered electrolyte storage tank 110 and communicably coupled to the sensors 60 and 62. In some examples, each of the power module 120 and the multi-chambered electrolyte storage tank 110 may be included in a single housing (not shown), such that the redox flow battery system 10 may be contained as a single unit in a single location. It will further be appreciated the positive electrolyte, the negative electrolyte, the sensors 60 and 62, the electrolyte rebalancing reactors 80 and 82, and the integrated multi-chambered electrolyte storage tank 110 (and components included therein) may be considered as being included in an electrolyte subsystem 130. As such, the electrolyte subsystem 130 may supply one or more electrolytes to the redox flow battery cell 18 (and components included therein).

As described above, hydrogen may be delivered within a redox flow battery system, including between a head space of a multi-chambered electrolyte tank, such as gas head spaces 90 and 92 of FIG. 1 and components of the redox flow battery which demand hydrogen, such as rebalancing reactors 80 and 82. Conventionally, hydrogen flow may be driven by a system including a combination of venturi injectors, dedicated liquid pumps and liquid/gas separators. However, this system includes many possible points of potential mechanical degradation or leakage in addition to the dedicated liquid pumps adding to a parasitic power demand. Instead, an electrolyte driven hydrogen pump may be a compact and comparatively simple system for moving hydrogen around the redox flow battery system. Using electrolyte flow to drive the hydrogen flow may decrease an amount of additional parasitic power demanded by the hydrogen pump system. Further, a demand for additional electrical power sources may be precluded by implementation of the electrolyte driven hydrogen pump, thereby maintaining costs low.

Referring now to FIG. 2, an example of an electrolyte driven hydrogen pump 200 is illustrated. Also shown in FIG. 2 is a coordinate system 201 including an x-axis, y-axis, and z-axis. Electrolyte driven hydrogen pump 200 may include pumping device 202 and turbine 208 which may be joined together by a common shaft 204. Pumping device 202 may be also referred to herein as impeller 202, however any pumping device capable of moving fluid by transfer of rotational energy has been considered within the scope of this disclosure. In this way, rotation of turbine 208 drives rotation of impeller 202, and turbine 208 and impeller 202 may rotate in unison. Further, a speed (e.g., rpm) of turbine 208 may be equal to a speed of impeller 202. In an alternate embodiment, gears 210 (or other equivalent components) may be coupled to common shaft 204 such that the speed of impeller 202 and turbine 208 are not equal. In one example, the gears 210 may be configured so the speed of impeller 202 is greater the speed of turbine 208. Alternatively, gears 210 may be configured so the speed of turbine 208 is greater than the speed of impeller 202.

Impeller 202 may include a plurality of blades configured to increase hydrogen gas flow through a hydrogen passage when spinning. Therefore, impeller 202 may be formed of a material compatible with long term hydrogen gas exposure, such as copper, copper alloys, aluminum, aluminum alloys, and/or hydrogen compatible polymers. Impeller 202 may be an open, closed, or semi-closed impeller.

Turbine 208 may be configured to extract energy from flowing electrolyte and transfer the energy to impeller 202 via common shaft 204. In one example, turbine 208 may be a circular paddle wheel. Turbine 208 may include a plurality of blades angled such that turbine 208 spins when electrolyte contacts and flows over the plurality of blades during operation of (e.g., charging, discharging and idling) a redox flow battery system (such as redox flow battery system 10 of FIG. 1). Turbine 208 may be formed of material compatible with long term exposure to low pH electrolytes, such as polypropylene (PP) or polytetrafluoroethylene (PTFE), among others.

Common shaft 204 may be supported by bearing block 206, which forms a sleeve that circumferentially surrounds a portion common shaft 204 and is positioned between impeller 202 and turbine 208. Bearing block 206 may support common shaft 204 while also allowing free rotation of common shaft 204. At least one seal may be positioned around common shaft 204 and between an outer surface of common shaft 204 and an inner surface of bearing block 206. In this way, transfer of hydrogen gas and/or electrolyte through an opening between bearing block 206 and common shaft 204 is prevented. The at least one seal may be formed of a material compatible with electrolyte and hydrogen gas such as a fluoroelastomer or ethylene propylene diene monomer (EPDM) rubber.

Electrolyte driven hydrogen pump 200 may be installed in a redox flow battery system, such as redox flow battery system 10 of FIG. 1, as shown in FIG. 3 in a diagram 300 of a portion of the redox flow battery system incorporating electrolyte driven hydrogen pump 200. Electrolyte driven hydrogen pump 200 may be positioned such that impeller 202 is within a hydrogen passage 302 and turbine 208 is within an electrolyte passage 306. In an alternate embodiment, electrolyte driven hydrogen pump 200 may be installed in other systems, where turbine 208 is arranged in a passage in a path of liquid flow and impeller 202 is installed within a gas passage to pump a gas or gasses.

In some examples, a diameter of turbine 208 may be larger than a diameter of impeller 202 as shown in FIGS. 2 and 3. However, other relative sizes of turbine 208 and impeller 202 have been considered within the scope of this disclosure. A size and geometry of impeller 202 and turbine 208 may be selected based on a desired impeller geometry, electrolyte flow rate, and/or hydrogen gas flow rate, among other factors.

Electrolyte passage 306 may be a passage where electrolyte continually flows during operation of the redox flow battery system. The electrolyte flowing through electrolyte passage 306 may be positive electrolyte and/or negative electrolyte. For example, electrolyte passage 306 may extend between an electrode compartment (e.g., negative electrode compartment 20 and/or positive electrode compartment 22 of FIG. 1) and a rebalancing cell (e.g., rebalancing cell 80 or 82 of FIG. 1) of the redox flow battery system. Electrolyte may flow due to operation of an electrolyte pump such as positive and/or negative electrolyte pumps 30 and 32 of FIG. 1

Hydrogen passage 302 may be a passage between a hydrogen storage tank and a component of the redox flow battery system which demands hydrogen. For example, hydrogen passage 302 may be a passage between a gas head space (e.g., gas head space 90 or 92 of FIG. 1) of an electrolyte storage tank and the rebalancing cell. Additionally or alternatively, hydrogen passage 302 may extend between a separate dedicated hydrogen storage tank and the rebalancing cell.

Hydrogen passage 302 may include a first junction section 310 and electrolyte passage 306 may include a second junction section 312. First junction section 310 may be parallel to and aligned with second junction section 312 along the x-axis. In this way, first junction section 310 may surround a first portion of bearing block 206 and common shaft 204 at an end closest to impeller 202 and second junction section 312 may surround a second portion of bearing block 206 and common shaft 204 at an end closest to turbine 208. In one example, electrolyte driven hydrogen pump 200 may be installed within the redox flow battery system at a location where electrolyte passage 306 and hydrogen passage 302 are within close proximity, thereby minimizing a length of junction sections 310 and 312 and of common shaft 204. Junction sections 310 and 312 may each be hermetically sealed to an outer surface of bearing block 206, thereby inhibiting exchange of hydrogen and electrolyte between the junction sections by sealing hydrogen gas within first junction section 310 and hydrogen passage 302 and sealing electrolyte within second junction section 312 and electrolyte passage 306.

Electrolyte may flow through electrolyte passage 306 in a direction of arrows 308 as propelled by an electrolyte pump of the redox flow battery system, such as positive or negative electrolyte pumps 30 and 32 of FIG. 1. Energy of flowing electrolyte may rotate turbine 208 in a first direction. Rotation of turbine 208 may be transferred to impeller 202 though common shaft 204 causing impeller 202 to turn in the same first direction. Rotation of impeller 202 may drive hydrogen gas through hydrogen passage 302 in a direction indicated by arrows 304. In this way, an electrolyte pump may drive flow of electrolyte, and electrolyte flow may indirectly drive hydrogen gas flow and a parasitic power demand of the redox flow battery system may be decreased. Additionally or alternatively, rotation of impeller 202 may drive rotation of turbine 208. For example, in case of degradation of the electrolyte pump, an additional hydrogen pump may drive hydrogen gas flow which may in turn drive flow of electrolyte.

Turning now to FIG. 4, schematic 400 shows an embodiment of an electrolyte driven hydrogen pump 402 positioned within a redox flow battery system, such as redox flow battery system 10 of FIG. 1. Schematic 400 includes a hydrogen passage 404 and an electrolyte passage 406. Flow of electrolyte through electrolyte passage 406 may rotate a turbine 403 of the electrolyte driven hydrogen pump 402 which may cause rotation of an impeller 401 of the electrolyte driven hydrogen pump, via coupling of turbine 403 to impeller 401 by a shaft 405, which may adjust flow of hydrogen gas through hydrogen passage 404.

A hydrogen bypass 408 may be coupled at a first end to hydrogen passage 404 downstream of impeller 401. Hydrogen bypass 408 may be coupled at a second end to hydrogen passage 404 upstream of impeller 401. A hydrogen bypass valve 410 may be positioned along hydrogen bypass 408 and may control flow of hydrogen gas through hydrogen bypass 408. In this way, if impeller 401 is still spinning but less hydrogen gas is demanded, at least a portion of hydrogen gas may be diverted from impeller 401 by opening hydrogen bypass valve 410. In one example, hydrogen bypass valve 410 may be adjusted to either a fully open position or to a fully closed position. In an alternate example, hydrogen bypass valve 410 may be continuously adjusted between a fully open position and a fully closed position. Hydrogen bypass valve 410 may be actuated by a controller such as controller 88 of FIG. 1 as commanded by a user of the redox flow battery system or automatically triggered by a sensor of the redox flow battery system.

Further, a flow controller 416, such a mass flow controller, may be coupled to hydrogen passage 404 downstream of impeller 401. Flow controller 416 may be actuated by the controller to modify a flow rate of hydrogen gas within a portion of hydrogen passage 404 downstream of flow controller 416. Additionally or alternatively, flow controller 416 may be configured to passively control a flow rate of hydrogen gas. As one example, flow controller 416 may be a restriction orifice. Additionally, the flow rate of hydrogen gas may be modified by adjusting a flow rate of electrolyte within electrolyte passage 406. For example, the flow rate of electrolyte may be modified by adjusting an amount of power supplied to an electrolyte pump (such as electrolyte pumps 30 and 32 of FIG. 1.) to vary an output, e.g., a pumping rate or speed, of the electrolyte pump.

An electrolyte bypass 412 may be coupled to electrolyte passage 406. A first end of electrolyte bypass may be coupled to electrolyte passage 406 upstream of turbine 403 of the electrolyte driven hydrogen pump 402 while a second end of electrolyte bypass may be coupled to electrolyte passage 406 downstream of turbine 403 of electrolyte driven hydrogen pump 402. An electrolyte bypass valve 414 may be positioned within electrolyte bypass 412 which may control flow of electrolyte through electrolyte bypass 412. In one example, electrolyte bypass valve may be adjusted to either a fully open position or a fully closed position. In another example, electrolyte bypass valve 414 may be continuously adjusted between the fully open position and the fully closed position. Electrolyte bypass valve 414 may be actuated by a controller such as controller 88 of FIG. 1 as commanded by the user of the redox flow battery system or automatically triggered by sensors of the redox flow battery system. In this way, a speed of the turbine, and thereby a speed of impeller 401, may be increased or decreased as the electrolyte bypass valve is opened or closed, respectively. For example, the redox flow battery system may demand a high electrolyte flow rate but a low hydrogen flow rate. A combination of opening electrolyte bypass valve 414, opening hydrogen bypass valve 410, and adjusting flow controller 416 may be used to decrease a hydrogen gas flow rate independent of an electrolyte flow demand.

In some embodiments, electrolyte flow may be modified by a passive electrolyte flow controller 418. As one example, passive electrolyte flow controller 418 may be a restriction plate. Passive electrolyte flow controller 418 may be optionally positioned upstream of turbine 403, thereby decreasing a flow rate of electrolyte over turbine 403 and decreasing hydrogen gas flow rate. Additionally or alternatively, passive electrolyte flow controller 418 may be positioned downstream of turbine 403. In this way, a flow rate of electrolyte over turbine 403 may be kept high if a high hydrogen gas flow rate is desired and electrolyte flow rate may be decreased before reaching a downstream component such as a rebalancing cell (e.g., rebalancing cell 80 and 82 of FIG. 1).

Turning now to FIG. 5, an example of a method 500 for operating a redox flow battery system including one or more electrolyte driven hydrogen pumps is shown. The one or more electrolyte driven hydrogen pumps may be the electrolyte driven hydrogen pump described above with respect to FIGS. 2-4 and the redox flow battery system may be the redox flow battery system described above with respect to FIG. 1. Accordingly, the one or more electrolyte driven hydrogen pumps may be positioned upstream of a component demanding hydrogen gas (e.g., rebalancing cell 80 and/or 82 of FIG. 1) and/or downstream of the component. In one example, the redox flow battery system may include both one or more hydrogen bypasses and one or more electrolyte bypasses, each of the one or more hydrogen bypasses and the one or more electrolyte bypasses positioned with respect to one of the one or more electrolyte driven hydrogen pumps as described above with respect to FIG. 4. In an alternate example, the redox flow battery system may include either the one or more hydrogen bypasses or the one or more electrolyte bypasses. In a further embodiment, neither the one or more hydrogen bypasses nor the one or more electrolyte bypasses may be included in the redox flow battery system. During normal operation of the redox flow battery system, a change in hydrogen gas pressure may not be demanded by components of the redox flow battery system, such as rebalancing reactors, and bypass valves of the redox flow battery system as described in FIG. 4 above, such as hydrogen bypass valve 410 and electrolyte bypass valve 414, may be normally open during operation of the redox flow battery system. Method 500 may be carried out via the controller 88 of FIG. 1, and may be stored as executable instructions at a non-transitory storage medium (e.g., memory) communicably coupled to controller 88. Method 500 may be executed upon activation of the redox flow battery system. For example, electrolyte flow may be driven and controlled by one or more pumps and valves and the battery system may be operating in a charging, discharging, or idling mode.

At 502, method 500 includes determining if there is a demand for a change in hydrogen gas pressure at a component. There may be a demand for a change in hydrogen gas pressure when the component demands addition or removal of hydrogen gas. As one example, the component may be one or more rebalancing cells (such as rebalancing cell 80 and/or 82 of FIG. 1). The demand for addition or removal of hydrogen gas may be determined based on signals from sensors of the redox flow battery system. For example, a pH sensor of the redox flow battery system may report a pH of an electrolyte outside of a target range which may indicate a demand for increased hydrogen pressure at one or more of the rebalancing cells or electrode compartments.

If method 500 determines that there is not a component which demands a change in hydrogen gas pressure, method 500 may continue to 504 to maintain normal operating conditions. As described above, normal operating conditions may include one or more electrolyte bypass valves in a fully open position (such as electrolyte bypass valve 414 of FIG. 4) which may divert electrolyte flow away from a turbine of the one or more electrolyte driven hydrogen pumps, thereby slowing or stopping rotation of the impeller. Additionally or alternatively, a normal operating condition may include one or more fully open hydrogen bypass valves (such as hydrogen bypass valve 410 of FIG. 4). An open hydrogen bypass valve may allow hydrogen gas to flow, at least partially, around the impeller, thus limiting an effect of the impeller on hydrogen gas flow. Method 500 returns.

If method 500 determines that a component of the redox flow battery does demand a change in hydrogen gas pressure, method 500 proceeds to 506 and includes increasing the flow of hydrogen gas. In some examples increasing a flow of hydrogen gas may include increasing hydrogen gas flow driven by the electrolyte driven hydrogen pump positioned downstream of the component in response to an increase in hydrogen gas pressure at the component. Alternatively, a decrease in pressure at the component may demand increasing a flow of hydrogen gas driven by an electrolyte driven hydrogen pump positioned upstream of the component. Hydrogen flow may be increased by closing the respective electrolyte bypass valve at 508 which may direct a flow of electrolyte over the turbine, thereby capturing energy of the flowing electrolyte and transferring that energy to the impeller to increase hydrogen gas flow. The electrolyte bypass may be closed fully or partially. Additionally or alternatively, increasing hydrogen gas flow may include closing the respective hydrogen bypass valve at 510, which may direct a flow of hydrogen gas towards the impeller. The hydrogen bypass valve may be closed fully or partially. In an example where the redox flow battery system does not include an electrolyte bypass or a hydrogen bypass, increasing hydrogen flow may include increasing an electrolyte flow rate at 511. Increasing the electrolyte flow rate may increase a rotational speed of the turbine, thereby increasing a rotational speed of the impeller resulting in an increased hydrogen flow.

At 512, method 500 includes determining if a flow rate of hydrogen gas to (e.g., increasing pressure) or away from (e.g., decreasing pressure) the component is greater than or equal to a target flow rate. Flow rate may be determined by a sensor of the redox flow battery system, such as a mass flow sensor. The target flow rate may include being limited to be below an upper threshold by a flow controller positioned downstream of the hydrogen impeller, such as a mass flow controller. If the hydrogen flow rate is at or above the target flow rate, the flow rate may be effectively controlled by the flow controller and method 500 proceeds to 514 which includes maintaining the current electrolyte and hydrogen flow rates. Method 500 returns.

If the flow rate of hydrogen gas is not greater than or equal to the target flow rate, method 500 proceeds to 516 and includes modifying the hydrogen flow rate. In one example, modifying hydrogen gas flow rate may include adjusting the respective electrolyte and/or hydrogen bypass valves at 518. The respective electrolyte and/or hydrogen bypass valves may be only partially closed, and adjusting the respective electrolyte and/or hydrogen bypass valves to a more fully or completely closed position may increase a speed of the respective impeller and thereby the hydrogen gas flow rate. Additionally, or alternatively, because the speed of the turbine in the electrolyte passage may be directly proportional to the speed of the impeller, the flow rate of hydrogen gas may be adjusted by adjusting a flow rate of the electrolyte at 520. Flow rate of the electrolyte may be adjusted by controlling a power delivered to electrolyte pumps (such as electrolyte pumps 30 and 32 of FIG. 1). Method 500 returns.

The technical effect of method 500 is that hydrogen gas is transferred throughout the redox flow battery system based on demand and desired flow rate. Adjusting bypass valves, flow controllers and pumps may efficiently direct a flow of hydrogen gas while minimizing a system complexity and heat output. Further, the use of electrolyte flow to power a hydrogen gas impeller may minimize parasitic power caused by demand for an additional liquid pump for directing a flow of hydrogen gas within the redox flow battery system. In this way, hydrogen may be moved with a lower power demand, complexity, and a decreased physical footprint within the redox flow battery system.

In another embodiment, a method of operating a redox flow battery system comprises modifying a flow of hydrogen gas by adjusting a hydrogen bypass valve positioned in a hydrogen bypass, wherein the hydrogen bypass diverts hydrogen away from a pumping device of a liquid driven hydrogen pump including the pumping device positioned in a path of the flow of the hydrogen gas, and a turbine coupled to the impeller and positioned in a path of flow of an electrolyte.

In another embodiment, a method of operating a redox flow battery system comprises modifying a flow of hydrogen gas by adjusting an electrolyte bypass valve positioned in an electrolyte bypass, wherein the electrolyte bypass diverts electrolyte away from a turbine of a liquid driven hydrogen pump including a pumping device positioned in a path of the flow of the hydrogen gas, and the turbine coupled to the pumping device and positioned in a path of flow of an electrolyte.

In another embodiment, a method of operating a redox flow battery system, comprises modifying a flow of hydrogen gas, in response to a demand for the hydrogen gas at a rebalancing reactor of the redox flow battery system, by adjusting a rotational speed of a liquid driven hydrogen pump, the liquid driven hydrogen pump including a pumping device positioned in a path of the flow of the hydrogen gas, and a turbine coupled to the pumping device and positioned in a path of flow of an electrolyte.

In another embodiment, a method of operating a redox flow battery system comprises modifying a flow of electrolyte by adjusting a rotational speed of a liquid driven hydrogen pump, the liquid driven hydrogen pump including a pumping device positioned in a path of the flow of the hydrogen gas, and a turbine coupled to the pumping device and positioned in a path of flow of an electrolyte.

In another embodiment, a method of operating a redox flow battery system, comprises: in response to a demand for increased hydrogen gas flow; closing a hydrogen bypass valve, directing hydrogen flow towards a pumping device of a liquid driven hydrogen pump, and closing an electrolyte bypass valve, directing electrolyte flow over a turbine of the liquid driven hydrogen pump; and in response to a hydrogen gas flow rate being below a target flow rate; adjusting a power of an electrolyte pump and/or a position of a bypass valve to increase the hydrogen gas flow rate.

FIGS. 2-3 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. FIGS. 2-3 are drawn approximately to scale, although other dimensions or relative dimensions may be used.

The disclosure also provides support for a liquid driven hydrogen pump for an electrochemical cell system, comprising: a pumping device positioned within a flow path of a gas, and a turbine coupled to the pumping device by a shaft and positioned within a flow path of a liquid, a flow of the liquid driven by a liquid pump based on operation of the electrochemical cell system, and wherein the flow of the liquid across the turbine drives rotation of the pumping device and an increase in a flow of the gas. In a first example of the system, the flow path of the gas extends between a gas head space of an electrolyte tank and a rebalancing reactor and/or between a hydrogen gas storage tank and the rebalancing reactor. In a second example of the system, optionally including the first example, the flow path of the gas extends downstream of a rebalancing reactor. In a third example of the system, optionally including one or both of the first and second examples, the flow path of the liquid extends between a rebalancing reactor and an electrolyte tank and/or between an electrode compartment and the rebalancing reactor. In a fourth example of the system, optionally including one or more or each of the first through third examples, the gas is hydrogen and the liquid is electrolyte. In a fifth example of the system, optionally including one or more or each of the first through fourth examples, the shaft is circumferentially surrounded by a bearing block, and wherein the bearing block includes at least one seal positioned between an inner surface of the bearing block and an outer surface of the shaft. In a sixth example of the system, optionally including one or more or each of the first through fifth examples, the turbine is configured as a paddle wheel. In a seventh example of the system, optionally including one or more or each of the first through sixth examples, the system further comprises: components capable of rotating the pumping device at a speed different than a speed of the turbine.

The disclosure also provides support for a method of operating an electrochemical cell, comprising: modifying a flow of hydrogen gas by adjusting a rotational speed of a liquid driven hydrogen pump, the liquid driven hydrogen pump including a pumping device positioned in a path of the flow of the hydrogen gas, and a turbine coupled to the pumping device and positioned in a path of flow of an electrolyte. In a first example of the method, the flow of hydrogen gas is modified based a demand of hydrogen gas by components of the electrochemical cell wherein the demand is based on signals from sensors of the electrochemical cell. In a second example of the method, optionally including the first example, a flow controller is positioned downstream of the pumping device of the liquid driven hydrogen pump and further modifies the flow of hydrogen gas. In a third example of the method, optionally including one or both of the first and second examples, the flow of hydrogen gas is modified by adjusting a flow rate of electrolyte in the path of the flow of electrolyte. In a fourth example of the method, optionally including one or more or each of the first through third examples, an electrolyte bypass valve is positioned within an electrolyte bypass of the electrochemical cell, and a position of the electrolyte bypass valve is adjusted to modify the flow of hydrogen gas. In a fifth example of the method, optionally including one or more or each of the first through fourth examples, a hydrogen bypass valve is positioned within a hydrogen bypass of the electrochemical cell, and a position of the hydrogen bypass valve is adjusted to modify the flow of hydrogen gas.

The disclosure also provides support for an electrochemical cell system, comprising: an electrolyte, an electrolyte pump configured to drive flow of the electrolyte through the electrochemical cell system, an electrolyte driven hydrogen pump having a turbine arranged in a path of the electrolyte and an impeller arranged in a path of hydrogen flow, the turbine configured to rotate in unison with the impeller, wherein rotation of the impeller is driven by rotation of the turbine, and rotation of the turbine is driven by the flow of the electrolyte. In a first example of the system, the path of hydrogen flow includes a first junction section, and the path of electrolyte flow includes a second junction section, the first and second junction sections positioned parallel and level with each other. In a second example of the system, optionally including the first example, the electrolyte driven hydrogen pump further includes a common shaft and a bearing block. In a third example of the system, optionally including one or both of the first and second examples, the first and second junction sections hermetically seal to an outer surface of the bearing block. In a fourth example of the system, optionally including one or more or each of the first through third examples, the path of hydrogen flow includes a hydrogen bypass and/or the path of electrolyte flow includes an electrolyte bypass. In a fifth example of the system, optionally including one or more or each of the first through fourth examples, the hydrogen bypass includes a hydrogen bypass valve positioned within the hydrogen bypass and the electrolyte bypass includes an electrolyte bypass valve positioned within the electrolyte bypass.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A liquid driven hydrogen pump for an electrochemical cell system, comprising:
a pumping device positioned within a flow path of a gas; and
a turbine coupled to the pumping device by a shaft and positioned within a flow path of a liquid, a flow of the liquid driven by a liquid pump based on operation of the electrochemical cell system, and wherein the flow of the liquid across the turbine drives rotation of the pumping device and an increase in a flow of the gas.

2. The liquid driven hydrogen pump of claim 1, wherein the flow path of the gas extends between a gas head space of an electrolyte tank and a rebalancing reactor and/or between a hydrogen gas storage tank and the rebalancing reactor.

3. The liquid driven hydrogen pump of claim 1, wherein the flow path of the gas extends downstream of a rebalancing reactor.

4. The liquid driven hydrogen pump of claim 1, wherein the flow path of the liquid extends between a rebalancing reactor and an electrolyte tank and/or between an electrode compartment and the rebalancing reactor.

5. The liquid driven hydrogen pump of claim 1, wherein the gas is hydrogen and the liquid is electrolyte.

6. The liquid driven hydrogen pump of claim 1, wherein the shaft is circumferentially surrounded by a bearing block, and wherein the bearing block includes at least one seal positioned between an inner surface of the bearing block and an outer surface of the shaft.

7. The liquid driven hydrogen pump of claim 1, wherein the turbine is configured as a paddle wheel.

8. The liquid driven hydrogen pump of claim 1, further comprising components capable of rotating the pumping device at a speed different than a speed of the turbine.

9. A method of operating an electrochemical cell, comprising:
modifying a flow of hydrogen gas by adjusting a rotational speed of a liquid driven hydrogen pump, the liquid driven hydrogen pump including a pumping device positioned in a path of the flow of the hydrogen gas, and a turbine coupled to the pumping device and positioned in a path of flow of an electrolyte.

10. The method of claim 9, wherein the flow of hydrogen gas is modified based a demand of hydrogen gas by components of the electrochemical cell wherein the demand is based on signals from sensors of the electrochemical cell.

11. The method of claim 9, wherein a flow controller is positioned downstream of the pumping device of the liquid driven hydrogen pump and further modifies the flow of hydrogen gas.

12. The method of claim 9, wherein the flow of hydrogen gas is modified by adjusting a flow rate of electrolyte in the path of the flow of electrolyte.

13. The method of claim 9, wherein an electrolyte bypass valve is positioned within an electrolyte bypass of the electrochemical cell, and a position of the electrolyte bypass valve is adjusted to modify the flow of hydrogen gas.

14. The method of claim 9, wherein a hydrogen bypass valve is positioned within a hydrogen bypass of the electrochemical cell, and a position of the hydrogen bypass valve is adjusted to modify the flow of hydrogen gas.

15. An electrochemical cell system, comprising:
an electrolyte;
an electrolyte pump configured to drive flow of the electrolyte through the electrochemical cell system; and
an electrolyte driven hydrogen pump having a turbine arranged in a path of the electrolyte and an impeller arranged in a path of hydrogen flow, the turbine configured to rotate in unison with the impeller, wherein rotation of the impeller is driven by rotation of the turbine, and rotation of the turbine is driven by the flow of the electrolyte.

16. The electrochemical cell system of claim 15, wherein the path of hydrogen flow includes a first junction section, and the path of electrolyte flow includes a second junction section, the first and second junction sections positioned parallel and level with each other.

17. The electrochemical cell system of claim 16, wherein the electrolyte driven hydrogen pump further includes a common shaft and a bearing block.

18. The electrochemical cell system of claim 17, wherein the first and second junction sections hermetically seal to an outer surface of the bearing block.

19. The electrochemical cell system of claim 15, wherein the path of hydrogen flow includes a hydrogen bypass and/or the path of electrolyte flow includes an electrolyte bypass.

20. The electrochemical cell system of claim 19, wherein the hydrogen bypass includes a hydrogen bypass valve positioned within the hydrogen bypass and the electrolyte bypass includes an electrolyte bypass valve positioned within the electrolyte bypass.
